(19) United States
(12) Patent Application Publication
(10) Pub. No.: US 2013/0337157 A1
(43) Pub. Date: Dec. 19, 2013

(54) METHOD FOR SYNTHESIZING METAL OR METAL OXIDE NANOPARTICLES BY LIQUID PHASE DEPOSITION ON THE SURFACE OF A SUBSTRATE

(71) Applicants: Arthur ROUSSEY, Villeurbanne (FR); Vincent Jousseaume, Le Sappey en Chartreuse (FR); Chloe Thieuleux, Villeurbanne (FR); Christophe Coperet, Zurich (CH)

(72) Inventors: Arthur ROUSSEY, Villeurbanne (FR); Vincent Jousseaume, Le Sappey en Chartreuse (FR); Chloe Thieuleux, Villeurbanne (FR); Christophe Coperet, Zurich (CH)

(73) Assignee: COMMISSARIAT A L'ENERGIE ATOMIQUE ET AUX ENE ALT, Paris (FR)

(21) Appl. No.: 13/524,774

(22) Filed: Jun. 15, 2012

(51) Int. Cl. H01B 13/00; B82Y 40/00

(52) U.S. Cl. 427/123; 427/126.3; 977/891

(57) ABSTRACT

The present invention relates to a method for synthesizing metal or metal oxide nanoparticles by liquid-phase deposition on a surface layer of a substrate, comprising the following successive steps:—a step of thermally pretreating the conductor or semiconductor surface layer of a substrate, comprising the application of a specified temperature;—a step of impregnating the pretreated surface layer of the substrate with an organometallic complex in solution in an aprotic solvent;—a step of annealing under controlled atmosphere, and wherein the specified temperature is selected to obtain a predefined size of nanoparticles between 4 and 60 nm with a dispersion less than or equal to 30%.

The invention is adapted to applications of nanoparticles in the field of microelectronics, optics or catalysis.

### TECHNICAL FIELD

The present invention relates to a method for synthesizing nanoparticles directly on a surface layer of a conductor or semiconductor substrate and to a method for synthesis of nanowires on the surface of the carrier substrate of these synthesized nanoparticles.

The invention is adapted to applications of nanoparticles in the field of microelectronics, optics or catalysis.

Metal nanoparticles are materials used for several decades in the field of chemistry, especially as catalysts or pigments. In fact, the size reduction compared with the raw material permits the development of new physicochemical properties and different reactivities. In addition, the decrease in size of the components used in microelectronics is now reaching sizes (<50 nm) at which the manufacturing techniques are becoming less reproducible and very costly. New methods for manufacturing nanoscale objects are therefore necessary to alleviate these problems and to derive the advantages of the aforementioned properties.

### PRIOR ART

Today, the use of nanoparticles in fields such as microelectronics is limited by the available manufacturing methods.

Ex situ synthesis of colloidal solution of nanoparticles followed by deposition thereof, for example by spin coating, permits the manufacture of nanoparticles of controlled size with narrow dispersion, typically at least less than 20%. However, their ex situ synthesis and their use imply a procedure of deposition on a substrate. Major drawbacks are encountered during this step because of the difficulty of controlling the process of evaporation of the liquid phase, which generates numerous defects. In addition, these nanoscale objects are surrounded by a protective layer, such as organic ligands or polymers, difficult to remove without losing the properties of the said nanoscale objects.

The method of deposition of a metal salt under traditional electroless conditions has rapid deposition kinetics and leads too quickly to metal films for the formation of nanoparticles to be controllable. In addition, the electroless baths use solutions containing toxic compounds (HF, formaldehyde, etc.) or are potentially contaminating (organic compounds, metal catalysts).

The dewetting of thin metal films, although well adapted to the current traditional methods of microelectronics, does not permit precise control of the size of the nanoparticles.

The preparation of nanoparticles on substrates of oxide type is also known. Two main approaches have already been described, but these methods do not permit satisfactory particle size control with good dispersion:
deposition of metal salt under aqueous conditions at controlled pH followed by annealing.
grafting of organometallic complexes on the surface of oxidized silica followed by treatment under hydrogen.

Other techniques exist but necessitate complex apparatuses, such as for vapor-phase deposition (physical vapor deposition) or chemical vapor-phase deposition (chemical vapor deposition) or metalorganic compound chemical vapor-phase deposition (MOCVD).

The use of nanoparticles in innovative applications, for example in microelectronics (memories, CVD catalysts, etc.) necessitates that they be isolated from one another and that their size dispersion be narrow. Depending on the intended application, the necessary size may vary greatly from 1 to 100 nm, but the dispersion must be fairly narrow.

These methods do not yield nanoparticles satisfactory for microelectronic applications such as growing nanowires on conductor or semiconductor substrates, where the nanoparticles have been obtained directly.

A need therefore exists to propose a method for synthesizing nanoparticles of predefined size with a narrow dispersion, compatible with traditional synthesis methods of microelectronics.

### DESCRIPTION OF THE INVENTION

The present invention attempts to overcome all or part of these drawbacks.

The invention proposes the synthesis of metal or metal oxide nanoparticles directly on a surface layer of a conductor or semiconductor surface. The synthesis comprises a step of pretreating the surface of the substrate then a step of impregnating the pretreated surface by an organometal complex in solution in an aprotic solvent then a step of annealing.

The method of preparing nanoparticles permits the choice of a predefined size of nanoparticles synthesized in a size range in which the diameter is between 4 and 60 nm and having a narrow dispersion less than or equal to 30%. This synthesis takes place directly on the surface layer of the conductor or semiconductor substrate by a simple method that makes it possible to use these nanoscale objects under conditions favorable to their use on the substrates used in microelectronics, in optics or in catalysis.

In particular, the network of synthesized nanoparticles has a density compatible with its application as catalyst for growing nanoscale objects, such as silicon nanowires, for example. Preferably, the final density of the nanoparticles on the surface layer of the substrate is quite high, for example from 10⁹ to 10¹¹ nanoparticles per cm² depending on the size of the nanoparticles.

Advantageously, the method according to the invention is compatible with a complementary metal oxide semiconductor (CMOS).

The invention is effective in particular on a substrate of silicon or passivated silicon or titanium nitride or passivated titanium nitride.

The synthesized nanoparticles are preferably copper nanoparticles.

It should be recalled that the invention relates to a method for synthesizing metal or metal oxide nanoparticles by liquid-phase deposition on a surface layer of a substrate comprising the following successive steps: a step of thermally pretreating the surface layer of the substrate, comprising the application of a specified temperature, the substrate being chosen as a conductor or semiconductor; a step of impregnating the pretreated surface layer of the substrate with an organometallic complex in solution in an aprotic solvent; a step of annealing under controlled atmosphere, and wherein the specified temperature is selected to obtain a predefined size of nanoparticles between 4 and 60 nm with a dispersion less than or equal to 30%.

According to preferred cumulative or alternative but non-limitative variants of the invention, the method is such that:
the pretreatment step is performed at a temperature between 18 and 1,000° C.
the pretreatment step is carried out under controlled atmosphere under vacuum or under flow of gas chosen from among hydrogen (H₂), ammonia (NH₃), oxygen (O₂), nitrogen (N₂) or silane (SiH₄).
the step of thermal pretreatment is preceded by a step of chemical pretreatment.
the pretreated surface layer of the substrate is in the form of passivated silicon of formula SiOₓ where x is larger than or equal to 0 and strictly smaller than 2.
after the pretreatment step, the pretreated surface layer of the oxidized silicon substrate comprises Si—H sites, the number of which per nm² is strictly larger than 0 and less than or equal to 9, and SiOH sites, the number of which per nm² is strictly larger than 0 and less than or equal to 6, analyzable, for example, by infrared spectroscopy.
the pretreated surface layer of the substrate is in the form of passivated titanium nitride of formula TiNₓO_{y} exhibiting two titanium lines at 415 and 417 eV and one oxygen line between 510 and 515 eV in Auger electron spectroscopy.
the organometallic complex is a copper complex.
the organometallic complex is chosen from among copper tert-butoxide or copper II acetate.
the aprotic solvent is chosen from among the alkanes between C5 and C10, for example, pentane, or from among ether, tetrahydrofuran, benzene or toluene.
the step of thermal pretreatment has a duration between 1 hour and 24 hours, advantageously 15 hours.
the organometallic complex has a concentration between 0.01 and 10 g/L, more precisely 0.1 to g/L, advantageously 0.25 g/L or else between 0.001 and 0.02 mol/L, advantageously 0.005 and 0.01 mol/L in the aprotic solvent.
the duration of the impregnation step is between 30 minutes and 24 hours, preferably 1 to 6 hours.
the impregnation step is carried out at a temperature between 0 and 70° C., more precisely between 18° and 25° C.
it comprises, after the impregnation step and before the annealing step, at least one step of washing of the surface layer of the substrate.
it comprises at least 1 to 5 successive steps of washing with an aprotic solvent.
it comprises, after the washing step and before the annealing step, a step of drying under vacuum for a duration preferably between 3 minutes and 1 hour.
the annealing step is carried out at a temperature between 100° and 800° C. under controlled atmosphere under vacuum or under flow of gas chosen from among hydrogen (H₂), nitrogen (N₂), argon (Ar), carbon monoxide (CO) or oxygen (O₂) at a pressure of 1 to 1,000 mbar.
the temperature is between 150° and 500° C.

According to another aspect, the invention relates to a method for synthesizing nanowires by chemical vapor-phase deposition characterized by the fact that it is carried out on the surface of the surface layer of the substrate carrying the nanoparticles synthesized by the method according to any one of claims 1 to 18.

### DETAILED DESCRIPTION OF THE INVENTION

The invention relates to a method for synthesizing metal or metal oxide nanoparticles by liquid-phase deposition directly on a conductor or semiconductor surface layer of a substrate.

Nanoparticles are nanoscale objects, the three dimensions of which are on the nanometer scale. The size of the nanoparticles is understood as their diameter.

According to a preferred possibility, the nanoparticles are nanoparticles of copper or copper oxide.

The substrate forming the surface layer is chosen to be a conductor or semiconductor, so as to make it possible to achieve a method of synthesizing nanowires directly from nanoparticles synthesized on the said surface layer.

The substrate is advantageously chosen so as to be reducing with respect to the metal chosen for the nanoparticles. Preferably, the said substrate must be reducing for copper. The chosen substrate must be a barrier for diffusion to the copper. The substrate is chosen from among silicon or titanium nitride or germanium or tantalum nitride or tantalum nitride/tantalum or the nitride of tantalum carbide or tungsten nitride or the nitride of tungsten carbide. According to the invention, the substrate is understood as the material which forms the surface layer and on which the pretreatment step is performed. It is possibly provided to create a film of the aforesaid materials on a base of a different material. For example, a film of titanium nitride is deposited on a base of silicon; the film of titanium nitride forms the substrate according to the invention.

The method according to the invention firstly comprises a step of pretreating the surface layer of the substrate. This pretreatment step is intended to control the surface state of the said surface layer of the substrate.

The pretreatment is thermal. Preferably, the thermal pretreatment is a heating of the substrate under controlled atmosphere. A specified temperature is applied to the substrate and more precisely to the surface layer. The specified temperature is between room temperature and 1,000° C., in other words between 18 and 1,000° C.

The heating duration is between 1 hour and 24 hours, preferably between 12 and 16 hours.

The phrase under controlled atmosphere includes thermal pretreatment under vacuum or under flow of gas, chosen from among ammonia (NH₃), hydrogen (H₂), oxygen (O₂), nitrogen (N₂), silane (SiH₄). By under vacuum there is understood a pressure between 10⁻² and 10⁻⁹ mbar.

According to one embodiment, the thermal pretreatment may be preceded by a step of chemical pretreatment. The chemical pretreatment is preferred for a substrate of titanium nitride. In particular, it makes it possible to obtain nanoparticles of size larger than 40 nm. The chemical pretreatment may be accomplished by aqueous hydrofluoric acid (HF) between 1% and 50%, preferably 1%, by immersion of the substrate or more specifically the surface layer of the substrate, for 10 seconds to 1 hour, preferably 30 seconds to 90 seconds. Advantageously, the surface layer is then washed with distilled water in order to control the thickness and nature of the surface oxide. The step of chemical pretreatment is carried out in controlled manner, either to remove the oxide partly, in other words to reduce its thickness, or to remove the oxide totally. The contact with the washing water then with the air/atmospheric humidity may make it possible to reoxidize the titanium nitride partly.

The pretreatment step, especially thermal, is intended to control the functionalities and the state of oxidation of the surface layer so that the size of the nanoparticles to be synthesized can be predicted.

According to the embodiment in which the surface layer of the substrate comprises silicon, the pretreatment step permits control of the number of SiH functionalities per nm² and/or of the number of SiOH functionalities per nm² and/or of the number of SiOSi functionalities per nm². Preferably, the surface layer comprises a number of SiH functionalities per nm² strictly larger than 0 and less than or equal to 9 and/or a number of SiOH functionalities per nm² strictly larger than 0 and less than or equal to 6. These functionalities are measured, for example by attenuated total reflection (ATR) infrared spectroscopy. The surface is globally silicon oxide of the type SiOₓ, where x is larger than or equal to 0 and strictly smaller than 2. The surface at the molecular level is more inhomogeneous. The surface of the substrate is of type SiOx, controllable by XPS, which permits detection of the presence of silicon in its different oxidation states: Si, Si⁺, Si²⁺, Si³⁺and Si⁴⁺. By Auger electron spectroscopy there is detected an Si line of energy between 1610 eV (pure SiO2) and 1619 eV (pure Si) and preferably between 1615 and 1618 eV. The intensity of the XPS signals of each component in XPS and the energy of the Auger line depend on the pretreatment temperature.

According to the embodiment in which the surface layer of the substrate comprises titanium nitride, the pretreatment step permits control of the quantity of oxygen at the surface. For the surface layer comprising oxidized titanium nitride, the type of oxide is TiNxOy. The measurement is carried out by Auger electron spectroscopy or by X-ray photon spectroscopy (XPS). The surface layer preferably comprises oxygen, to such an extent that, in XPS, the TiO component at 458 eV in the peak group of the energy of the Ti 2p bond represents between 1 and 99% and preferably between 10 and 40% of this peak group, the rest being due to the TiN bond at 455 eV and the TiNO bond at 456 eV. The stoichiometry can be measured by comparing the intensity of the O1s and N1s signals by XPS. Advantageously, the ratio of the intensities is between I (O1s)/I(N1s)=0.1 and 10, and preferably between 0.4 and 3.

By Auger electron spectroscopy, TiNₓO_{y} exhibits two titanium lines at 415 and 417 eV and one oxygen line between 510 and 515 eV.

Surprisingly, this pretreatment step makes it possible to control the quantity of metal, more precisely of copper, deposited on the surface layer during the impregnation step, and/or the energy of adhesion between the deposited metal and the surface during the annealing step, and therefore to define the size of the nanoparticles that are synthesized.

According to one possibility, the substrate may be passivated before the pretreatment. By passivated it is understood that the surface layer of the substrate is oxidized by a native oxide: a natural phenomenon of oxidation of the surface of a metal exposed to the air.

Advantageously, after the pretreatment step, the substrate, more precisely the surface layer, is kept shielded from any contact with air in order to preserve the properties of the generated surface layer. Preferably, the rest of the method is carried out without exposure to the air.

After the pretreatment step, the method according to the invention comprises a step of impregnating the surface layer of the substrate with an organometallic complex in solution.

The solution is preferably prepared with an aprotic solvent, so as to not influence the surface state and especially the oxidation of the surface layer.

The organometallic complex is preferably an organometallic complex of copper. The metal chosen for this organometallic complex defines the nature of the synthesized nanoparticles.

Preferably, the organometallic complex is a copper complex chosen from among an organometallic complex of copper I or an organometallic complex of copper II and preferably the tert-butoxide of copper I.

The aprotic solvent is chosen such that the organometallic complex, more precisely the organometallic complex of copper, is soluble. For example, the solvent is chosen from among the C5 to C10 alkanes, preferably pentane, or from among ether, tetrahydrofuran, benzene or toluene.

The solution has a concentration between 0.01 and 10 g/L, more precisely 0.1 to 1 g/L, advantageously 0.25 g/L depending on the solubility of the complex. Preferably, the concentration ranges from 0.001 mol/L to 0.02 mol/L, more precisely 0.003 to 0.01 mol/L of copper.

The impregnation step consists of depositing the solution at the surface of the surface layer of the substrate. The solution is brought into contact with the said surface for 30 minutes to 24 hours, preferably from 1 to 6 hours, advantageously 5 hours. The duration of contact is determined according to the predefined size of the nanoparticles to be synthesized.

This impregnation step permits chemisorption and/or physisorption of the organometallic complex and/or deposition of the metal with elimination of ligands and/or disproportionation of the organometallic complex of copper at the surface of the surface layer of the substrate.

The impregnation step is advantageously performed at room temperature between 18 and 25° C.

According to one possibility, the method comprises, after the impregnation step and before an annealing step, at least one washing step. This washing step consists of rinsing the surface layer of the substrate with an aprotic solvent, preferably by immersion. The solvent is advantageously chosen from among the C5 to C10 alkanes, preferably pentane, or from among ether, tetrahydrofuran, benzene or toluene. It may be different from the solvent used to solubilize the organometallic complex, but it is preferred that the organometallic complex be soluble in it.

This washing step makes it possible to remove the excess organometallic complex from the surface of the surface layer of the substrate, and especially the physisorbed metal.

This washing step may be repeated. The method preferably comprises 1 to 5 washing steps.

After the washing step, the method advantageously comprises a drying step, for example under vacuum, for example from 2 minutes to 1 hour.

According to the invention, the method comprises, after the impregnation step and if appropriate after the washing and drying step or steps, an annealing step. The annealing step is preferably carried out under controlled atmosphere, for example under gas flow or under vacuum.

The gases used are, for example, hydrogen (H₂), argon (Ar), nitrogen (N₂), nitric oxide (NO) or carbon monoxide (CO).

This step may be carried out under pressure between 1 and 1,000 mbar.

By way of example, the annealing is carried out at a temperature between 100° and 800° C., preferably 150° and 500° C., advantageously 200° C.

The annealing step is intended to terminate and stabilize the formation of the nanoparticles at the surface of the surface layer of the substrate.

The size of the nanoparticles is controlled by the structure of the surface after the thermal treatment. In fact, the size of the nanoparticles is controlled by the density of nucleation sites, for example Si—OH, Si—H, for a surface layer comprising silicon, as well as the quantity of metal potentially reducible by the surface layer via a mechanism of galvanic displacement, the oxidation of the surface layer and its permeability to electrons becomes the factor limiting the growth of the nanoparticles.

The annealing step makes it possible to reduce the chemisorbed and/or physisorbed metal species and in addition to make the size of the nanoparticles grow in controlled manner, especially via the surface/metal interactions.

The method according to the invention, while permitting synthesis of nanoparticles in situ directly on a surface layer of a conductor or semiconductor substrate, facilitates the microelectronics methods by reducing the number of manipulations.

The method of the invention makes it possible to synthesize nanoparticles free of protective layers or of contaminants such as stabilizers, as is the case during synthesis, for example, from colloidal solution.

In this method, an additional chemical reducing agent is not used.

The invention permits the synthesis of nanoparticles, preferably of copper, of predetermined size in a very broad size range from 4 to 60 nm, but in very controlled manner, since the dispersion is narrower than 30% and preferably 10%.

In addition, the final density of the nanoparticles on the surface layer of the substrate is advantageously quite high, for example from 10⁹ to 10¹¹ nanoparticles per cm² depending on the size of the nanoparticles.

Without being confined to one theory, the Applicants have concluded that this control of the size of the synthesized nanoparticles is mainly due to the pretreatment step and more precisely to the applied specified temperature.

The surface layer carrying the synthesized nanoparticles may be used to synthesize nanowires directly by traditional methods of synthesis of nanowires.

### EXAMPLES

### Example 1

A silicon wafer is treated under vacuum at 1,000° C. for 6 hours. Using traditional Schlenk techniques, it is then cooled and subsequently brought into contact at room temperature with a solution of copper (I) tert-butoxide in pentane having a concentration of 0.25 g/L. After 24 hours of deposition, the surface is washed three times with pentane, dried under vacuum then treated for 24 hours under 1 bar hydrogen at 200° C. The nanoparticles obtained are of 9+/−3 nm with a density of 5×10¹⁰ nanoparticles/cm².

### Example 2

A silicon wafer is treated under vacuum at 700° C. for 6 hours. Using traditional Schlenk techniques, it is then cooled and subsequently brought into contact at room temperature with a solution of copper (I) tert-butoxide in pentane having a concentration of 0.25 g/L. After 24 hours of deposition, the surface is washed three times with pentane, dried under vacuum then treated for 24 hours under 1 bar hydrogen at 200° C. The nanoparticles obtained are of 10+/−4 nm with a density of 5.5×10¹⁰ nanoparticles/cm².

### Example 3

A silicon wafer is treated under vacuum at 425° C. for 6 hours. Using traditional Schlenk techniques, it is then cooled and subsequently brought into contact at room temperature with a solution of copper (I) tert-butoxide in pentane having a concentration of 0.25 g/L. After 24 hours of deposition, the surface is washed three times with pentane, dried under vacuum then treated for 24 hours under 1 bar hydrogen at 200° C. The nanoparticles obtained are of 4+/−1.5 nm with a density of 5.5×10¹¹ nanoparticles/cm².

### Example 4

A silicon wafer is treated under vacuum at 200° C. for 6 hours. Using traditional Schlenk techniques, it is then cooled and subsequently brought into contact at room temperature with a solution of copper (I) tert-butoxide in pentane having a concentration of 0.25 g/L. After 24 hours of deposition, the surface is washed three times with pentane, dried under vacuum then treated for 24 hours under 1 bar hydrogen at 200° C. The nanoparticles obtained are of 25+/−11 nm with a density of 1.1×10¹⁰ nanoparticles/cm².

### Example 5

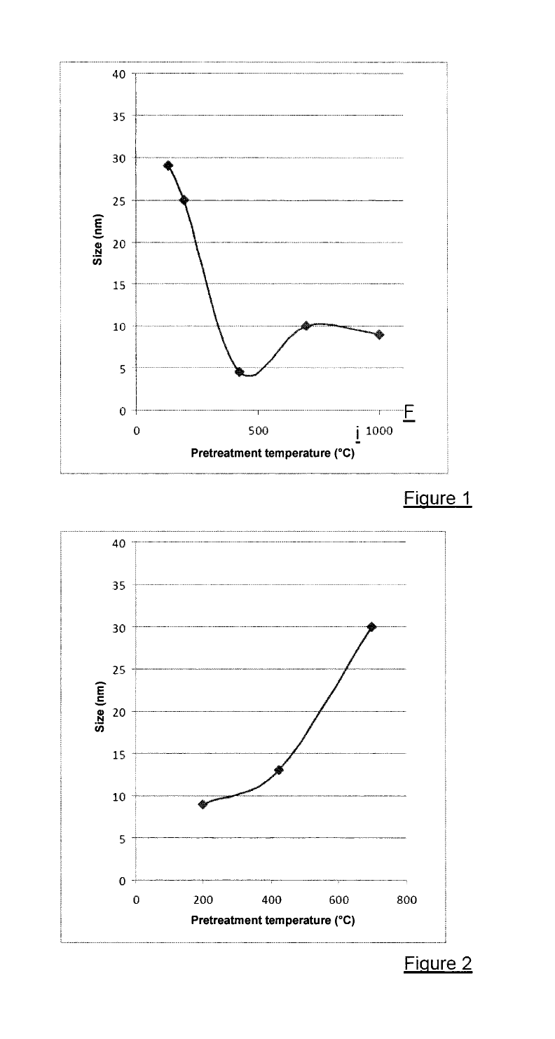

A silicon wafer is treated under vacuum at 135° C. for 6 hours. Using traditional Schlenk techniques, it is then cooled and subsequently brought into contact at room temperature with a solution of copper (I) tert-butoxide in pentane having a concentration of 0.25 g/L. After 24 hours of deposition, the surface is washed three times with pentane, dried under vacuum then treated for 24 hours under 1 bar hydrogen at 200° C. The nanoparticles obtained are of 29+/−9 nm with a density of 0.4×10¹⁰ nanoparticles/cm². A curve of size as a function of pretreatment temperature is plotted: FIG. 1.

### Example 6

The surface layer of a substrate of titanium nitride of 10 nm, deposited on a silicon wafer, is treated under vacuum at 200° C. for 12 hours. It is then cooled and, using traditional Schlenk techniques, is subsequently brought into contact at room temperature with a solution of copper (I) tert-butoxide in pentane having a concentration of 0.25 g/L. After 5 hours of deposition, the surface is washed three times with pentane, dried under vacuum then treated for 24 hours under 1 bar hydrogen at 200° C. The nanoparticles obtained are of 9+/−3 nm with a density of 3.4×10¹⁰ nanoparticles/cm².

### Example 7

The surface layer of a substrate of titanium nitride of 10 nm, deposited on a silicon wafer, is treated under vacuum at 425° C. for 12 hours. It is then cooled and, using traditional Schlenk techniques, is subsequently brought into contact at room temperature with a solution of copper (I) tert-butoxide in pentane having a concentration of 0.25 g/L. After 5 hours of deposition, the surface is washed three times with pentane, dried under vacuum then treated for 24 hours under 1 bar hydrogen at 200° C. The nanoparticles obtained are of 13+/−3 nm with a density of 5×10¹⁰ nanoparticles/cm².

### Example 8

The surface layer of a substrate of titanium nitride of 10 nm, deposited on a silicon wafer, is treated under vacuum at 700° C. for 12 hours. It is then cooled and, using traditional Schlenk techniques, is subsequently brought into contact at room temperature with a solution of copper (I) tert-butoxide in pentane having a concentration of 0.25 g/L. After 5 hours of deposition, the surface is washed three times with pentane, dried under vacuum then treated for 24 hours under 1 bar hydrogen at 200° C. The nanoparticles obtained are of 32+/−10 nm with a density of 0.5×10¹⁰ nanoparticles/cm².

### Example 9

The surface layer of a substrate of titanium nitride of 10 nm, deposited on a silicon wafer, is treated for 30 seconds in 1% HF solution then washed with deionized water. It is then placed under vacuum for 1 hour. Using traditional Schlenk techniques, it is then brought into contact at room temperature with a solution of copper (I) tert-butoxide in pentane having a concentration of 0.25 g/L. After 24 hours of deposition, the surface is washed three times with pentane, dried under vacuum then treated for 24 hours under 1 bar hydrogen at 200° C. The nanoparticles obtained are of 61+/−13 nm with a density of 0.15×10¹⁰ nanoparticles/cm². A curve of size as a function of pretreatment temperature is plotted: FIG. 2.

### Example 10

method for synthesizing nanowires. A substrate obtained according to one of Examples 1 to 5 is heated between 400 and 1,200° C. under hydrogen flow, for example between 1 and 2,000 sccm, with a pressure of 1 torr to 750 torr, up to the desired temperature, in order to achieve growth of nanowires. This temperature is maintained for 1 minute to 2 hours. Thereafter a flow of silane (SiH4), diluted if necessary in other gases such as hydrogen or helium, is added for 1 minute to 1 hour with a flow of 1 to 250 sccm and a pressure of 1 torr to 50 torr, in order to achieve growth of nanowires.

1. A method for synthesizing metal or metal oxide nanoparticles by liquid-phase deposition on a surface layer of a substrate, comprising the following successive steps:
a step of thermally pretreating the surface layer of the substrate, comprising the application of a specified temperature, the substrate being chosen as a conductor or semiconductor;
a step of impregnating the pretreated surface layer of the substrate with an organometallic complex in solution in an aprotic solvent;
a step of annealing under controlled atmosphere and wherein the specified temperature is selected to obtain a predefined size of nanoparticles between 4 and 60 nm with a dispersion less than or equal to 30%.

2. A method according to the preceding claim, wherein the pretreatment step is performed at a temperature between 18 and 1,000° C.

3. A method according to claim 1, wherein the pretreatment step is carried out under controlled atmosphere under vacuum or under flow of gas chosen from among hydrogen (H₂), ammonia (NH₃), oxygen (O₂), nitrogen (N₂) or silane (SiH₄).

4. A method according to claim 1, wherein the pretreated surface layer of the substrate is in the form of passivated silicon of formula SiOₓ where x is larger than or equal to 0 and strictly smaller than 2.

5. A method according to claim 1, wherein, after the pretreatment step, the pretreated surface layer of the substrate comprises SiOH sites, the number of which per nm² is strictly larger than 0 and less than or equal to 9, and SiOH sites, the number of which per nm² is strictly larger than 0 and less than or equal to 6.

6. A method according to claim 1, wherein the pretreated surface of the substrate is in the form of passivated titanium nitride of formula TiNₓO_{y} exhibiting two titanium lines at 415 and 417 eV and one oxygen line at 417 eV in Auger electron spectroscopy.

7. A method according to claim 1, wherein the organometallic complex is a copper complex.

8. A method according to claim 1, wherein the organometallic complex is chosen from among an organometallic complex of copper I or an organometallic complex of copper II and preferably the tert-butoxide of copper I.

9. A method according to claim 1, wherein the aprotic solvent is chosen from among the C5 to C10 alkanes, preferably pentane, or from among ether, tetrahydrofuran, benzene or toluene.

10. A method according to claim 1, wherein the step of thermal pretreatment has a duration between 1 hour and 24 hours, advantageously 15 hours.

11. A method according to claim 1, wherein the step of thermal pretreatment is preceded by a step of chemical pretreatment.

12. A method according to claim 1, wherein the organometallic complex has a concentration between 0.01 and 10 g/L, advantageously 0.25 g/L in the aprotic solvent.

13. A method according to claim 1, wherein the duration of the impregnation step is between 30 minutes and 24 hours, preferably 1 to 6 hours.

14. A method according to claim 1, wherein the impregnation step is carried out at a temperature between 18° and 25° C.

15. A method according to claim 1, comprising, after the impregnation step and before the annealing step, at least one step of washing of the surface layer of the substrate.

16. A method according to claim 1, comprising at least 1 to 5 successive steps of washing with an aprotic solvent.

17. A method according to claim 15, comprising, after the washing step and before the annealing step, a step of drying under vacuum for a duration between 3 minutes and 1 hour.

18. A method according to claim 1, wherein the annealing step is carried out at a temperature between 100° and 800° C. under controlled atmosphere under vacuum or under flow of gas chosen from among hydrogen (H₂), nitrogen (N₂), argon (Ar), carbon monoxide (CO) or oxygen (O₂) at a pressure of 1 to 1,000 mbar.

19. A method according to claim 18, wherein the temperature is between 150° and 500° C.

20. A method for synthesizing nanowires by chemical vapor-phase deposition characterized by the fact that it is carried out on the surface of the surface layer of the substrate carrying the nanoparticles synthesized by the method according to claims 1 to 18.
